(19) United States
(12) Patent Application Publication
(10) Pub. No.: US 2018/0369043 A1
(43) Pub. Date: Dec. 27, 2018

(54) PATIENT LIFT

(71) Applicant: Lamin Fofana, Durham, NC (US)

(72) Inventor: Lamin Fofana, Durham, NC (US)

(21) Appl. No.: 15/628,846

(22) Filed: Jun. 21, 2017

(51) Int. Cl. A61G 7/10

(52) U.S. Cl. CPC A61G 7/1013; A61G 7/1051; A61G 7/1044; A61G 7/10

(57) ABSTRACT

A patient lift that includes: a vertical support brace, wherein the vertical support brace is attached to a bed; a boom extending from the vertical support brace; a power unit attached to a distal end of the boom; a load bracket extending from the power unit; a sling brace attached to the load bracket; and sling hooks at end of the sling brace; and a body sling adapted to support a body and removably attached to the sling hooks. The power unit also includes weight scale. The boom preferably extends at a 90-degree angle from the vertical support brace.

### BACKGROUND OF THE INVENTION

### Field of Invention

The present invention relates to a patient lift to assist in the movement of a bedbound patient.

### Description of Related Art

Patients in medical facilities such as hospitals and elderly care facilities must constantly be moved for various reasons related to care. Many times patients are able to assist in movement around a bed or into a wheelchair however some patients are completely bedbound and immobile. Such patients normally require lifts either installed within the bed or adjacent to the bed to lift their bodies while being administered care in a hospital or other patient care facility. Various types of lifts have been developed to assist in lifting patients. One popular lift is the Hoyer lift. The Hoyer lift provides a means to lift the patient and move them about a hospital room. However the Hoyer lift still requires a significant amount of manual assistance in moving the patient. As a result it would be advantageous to have a completely automated lift.

### SUMMARY OF THE INVENTION

The present invention relates to a patient lift that includes: a vertical support brace, wherein the vertical support brace is attached to a bed; a boom extending from the vertical support brace; a power unit attached to a distal end of the boom; a load bracket extending from the power unit; a sling brace attached to the load bracket; and sling hooks at end of the sling brace; and a body sling adapted to support a body and removably attached to the sling hooks. The power unit also includes weight scale. The boom preferably extends at a 90 degree angle from the vertical support brace.

### BRIEF DESCRIPTION OF DRAWINGS

FIG. 1 depicts a perspective view of a patient lift in accordance with the present invention.

### DETAILED DESCRIPTION

The present invention relates to a patient lift that includes a vertical support with a boom extended from the vertical support. A power unit is provided at a distal end of the boom with an extending load bracket. The load bracket includes a sling brace that has attachment hooks at each end of the sling brace. The sling brace expands horizontally and is adapted to receive a body sling that is used to support the body of a patient. During operation the load bracket is lowered to effectively attach the removably attachable body sling. Once attached to this sling the patient may be lifted with the load bracket and therefore have a suitable means to lift the patient. Other aspects of the patient lift is a scale incorporated into the power unit to have a means to weigh the patient within the body sling. Preferably the boom extends at a 90-degree angle from the vertical support brace, where the vertical support brace is attached to a bed. Further the vertical support brace is preferably placed at the head of the bed where the boom extends over the bed providing a lift mechanism.

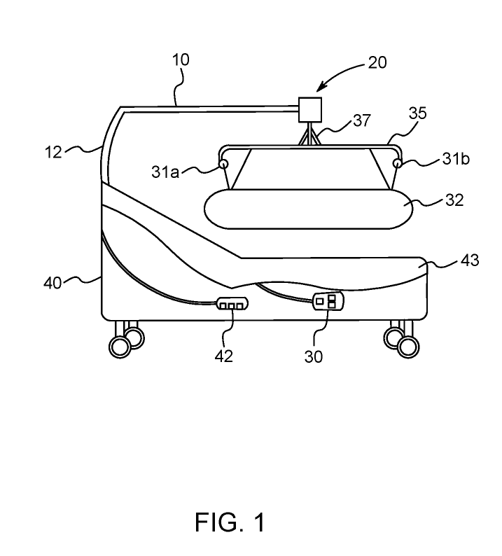

In reference to FIG. 1, a perspective view of a patient lift according to the present invention is depicted. The patient lift is installed on a medical bed 40 as shown in FIG. 1. The lift includes a vertical support brace 12 with a boom 10 extending therefrom. As shown in FIG. 1 the boom extends at about a 90-degree angle and has a power unit 20 at the distal end thereof. The power unit includes a load bracket 37 that supports a sling brace 35. The sling brace 35 includes hooks 31a, 31b to attach a body sling 32 thereto. Once attached this sling 32 may be maneuvered to vertically lift a patient from a bed 40. The sling 32 may be placed on top of the mattress 43 of the bed 40. A patient is placed within the sling 32 prior to attachment to the hooks 31a, 31b.

Further aspects of the patient lift include the vertical support brace 12 and boom 10 rotate within a horizontal plane to allow horizontal movement of the patient. Control modules are provided as shown in FIG. 1. A control module 42 is provided for the patient lift and a bed control module 30 is provided for the bed. During use this sling and lift are used in conjunction to effectively lift and maneuver a patient within a medical bed.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A patient lift comprising:
a. a vertical support brace, wherein the vertical support brace is attached to a bed;
b. a boom extending from the vertical support brace;
c. a power unit attached to a distal end of the boom;
d. a load bracket extending from the power unit;
e. a sling brace attached to the load bracket; and
f. sling hooks at end of the sling brace; and
g. a body sling adapted to support a body and removably attached to the sling hooks.

2. The patient lift according to claim 1, where the power unit includes weight scale.

3. The patient lift according to claim 1, where the boom extends at a 90 degree angle from the vertical support brace.

4. The patient lift according to claim 1, further including a lift control module which controls the movement of the lift.

5. The patient lift according to claim 1, where vertical support brace and boom rotate.
